(19) United States
(12) Patent Application Publication
(10) Pub. No.: US 2023/0330935 A1
(43) Pub. Date: Oct. 19, 2023

(54) LIGHT SOURCE VARIABILITY CORRECTION IN ADDITIVE MANUFACTURING

(71) Applicant: Carbon, Inc., Redwood City, CA (US)

(72) Inventors: Ariel M. Herrmann, Mountain View, CA (US); John R. Tumbleston, Menlo Park, CA (US); Kyle R. Laaker, Redwood City, CA (US); Sean P. Wheeler, San Jose, CA (US); Elliott Steele Baker, San Mateo, CA (US); Alexander Portnoy, Los Gatos, CA (US); Nicholas M. DeNardo, Denver, CO (US); Anant Chimmalgi, Los Altos, CA (US)

(21) Appl. No.: 18/302,227

(22) Filed: Apr. 18, 2023

Related U.S. Application Data
(60) Provisional application No. 63/332,423, filed on Apr. 19, 2022.

(51) Int. Cl. B29C 64/282; B29C 64/393; B29C 64/129

(52) U.S. Cl. CPC B29C 64/282; B29C 64/393; B29C 64/129; B33Y 30/00

(57) ABSTRACT

A method of reducing performance deviation in at least one additive manufacturing apparatus during production of parts is provided. Each apparatus has a light source configured for polymerizing a light polymerizable resin with sequential doses of patterned light to produce a 3D object. The light source has an assigned nominal emission data, such as an expected or preset standard emission data, and actual emission data. The method includes modifying at least some of said light doses in said at least one apparatus during production of parts therein to compensate for a deviation of said actual light source emission data from the assigned nominal emission data.

### RELATED APPLICATIONS

This application claims priority from U.S. Provisional Application Ser. No. 63/332,423, filed Apr. 19, 2022, the disclosure of which is incorporated by reference in its entirety.

This invention concerns additive manufacturing, and particularly systems and methods for reducing part production variability caused by variations between light sources in multiple additive manufacturing apparatus, and/or deviation of actual light source emission from expected light source emission.

### BACKGROUND

The development of continuous liquid interface production (CLIP) has accelerated the transition of additive manufacturing techniques from prototyping to the production of parts intended for commercial use (see, e.g., U.S. Pat. Nos. 9,211,678; 9,205,601; and U.S. Pat. No. 9,216,546 to DeSimone et al.; see also J. Tumbleston, D. Shirvanyants, N. Ermoshkin et al., Continuous liquid interface production of 3D Objects, Science 347, 1349-1352 (2015)). This transition has focused attention on the accuracy and consistency of the process, as parts such as electrical and mechanical connectors are often produced in large numbers to high accuracy standards. Batch-to-batch resin variability has been identified as one source of additive manufacturing variability for which corrective steps can be taken (see Tumbleston et al., Performance optimization in additive manufacturing, US Patent Application Pub. App. No. US 2020/0276765 (Sep. 3, 2020), but there remains a need for new approaches to correct other sources of variability.

### SUMMARY

A method of reducing performance deviation in at least one additive manufacturing apparatus during production of parts is described herein. Each apparatus has a light source configured for polymerizing a light polymerizable resin with sequential doses of patterned light to produce a 3D object. The light source has an assigned nominal (i.e., expected or preset standard) emission data, as well as actual emission data. The method includes modifying at least some of said light doses in each said at least one apparatus during production of parts therein to compensate for a deviation of said actual light source emission data from the assigned nominal emission data.

In some embodiments, the actual emission data is predetermined (e.g., measured upon installation in the apparatus, during subsequent servicing of an apparatus during the lifetime service use of that apparatus, etc.); in other embodiments, the actual emission data is periodically determined (e.g., updated periodically during use of the machine, or contemporaneously determined for production of specific parts or objects from a specific resin batch).

In some embodiments, the emission data is periodically determined with a light sensor (such as a spectrophotometer) installed in the apparatus; in other embodiments, the actual emission data is periodically determined with a first principles model, an empirical model, or a combination thereof.

In some embodiments, the actual and nominal emission data consists of a single parameter, such as an emission spectra peak value. In other embodiments, the actual and nominal emission data consists of multi-parameter data.

The foregoing and other objects and aspects of the present invention are explained in greater detail in the drawings herein and the specification set forth below. The disclosures of all United States patent references cited herein are to be incorporated herein by reference.

### BRIEF DESCRIPTION OF THE DRAWINGS

FIG. 1 schematically illustrates an example additive manufacturing apparatus (a “printer”).

FIG. 2 illustrates a photoinitiator absorbance spectra (for a photoiniator in an additive manufacturing resin) as compared to an expected light source emission spectra.

FIG. 3 schematically illustrates a controller for an additive manufacturing apparatus as is known in the art.

FIG. 4A illustrates a photoinitiator absorbance spectra as compared to three different actual light source emission spectra (as may be found in three different additive manufacturing apparatus).

FIG. 4B is an additional example illustrating a photoinitiator absorbance spectra as compared to three different actual light source emission spectra.

FIG. 5 schematically illustrates a controller for an additive manufacturing apparatus configured for carrying out the methods described herein.

FIG. 6 is a pair of graphs illustrating a change in cure characteristics of a resin across wavelengths.

FIG. 7 illustrates an empirical model that uses the expected curethrough output of a first principles model for a printer's nominal wavelength, which empirical model calculates the cure-through and overcure at a printers' actual wavelength, so that adjustments can be made to cause objects to be printed as though there were printed at the nominal wavelength. Line A represents a print process with a slice thickness of 50 microns, and line B represents a print process with a slice thickness of 100 microns.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

As used herein, the term “and/or” includes any and all possible combinations of one or more of the associated listed items, as well as the lack of combinations when interpreted in the alternative (“or”).

### 1. Light-Based Additive Manufacturing.

Additive manufacturing with photopolymerizable resins is generally carried out by any of a family of methods generally referred to as stereolithography. These methods, whether carried out with scanning lasers, micromirror arrays, or any other light source configuration, typically include bottom-up and top-down techniques. Various versions are known and described in, for example, U.S. Pat. No. 5,236,637 to Hull, U.S. Pat. No. 5,247,180 to Mitcham and Nelson; U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and US Patent Application Publication No. 2013/0295212 to Chen et al. The disclosures of these patents and applications are incorporated by reference herein in their entirety.

In some embodiments, the apparatus and method used herein is an improved version of stereolithography known as continuous liquid interface production (CLIP). CLIP is known and described in, for example, PCT Application Nos. PCT/US2014/015486 (U.S. Pat. No. 9,211,678); PCT/US2014/015506 (U.S. Pat. No. 9,205,601), PCT/US2014/015497 (U.S. Pat. No. 9,216,546), and in J. Tumbleston, D. Shirvanyants, N. Ermoshkin et al., Continuous liquid interface production of 3D Objects, Science 347, 1349-1352 (2015). See also R. Janusziewcz et al., Layerless fabrication with continuous liquid interface production, Proc. Natl. Acad. Sci. USA 113, 11703-11708 (Oct. 18, 2016). Other approaches for carrying out CLIP that can be used in the present invention and obviate the need for a semipermeable “window” or window structure include utilizing a liquid interface comprising an immiscible liquid (see L. Robeson et al., WO 2015/164234, published Oct. 29, 2015), generating oxygen as an inhibitor by electrolysis (see I. Craven et al., WO 2016/133759, published Aug. 25, 2016), and incorporating magnetically positionable particles to which the photoactivator is coupled into the polymerizable liquid (see J. Rolland, WO 2016/145182, published Sep. 15, 2016).

Other examples of methods and apparatus for carrying out particular embodiments of CLIP include, but are not limited to: Batchelder et al., Continuous liquid interface production system with viscosity pump, US Patent Application Pub. No. US 2017/0129169 (May 11, 2017); Sun and Lichkus, Three-dimensional fabricating system for rapidly producing objects, US Patent Application Pub. No. US 2016/0288376 (Oct. 6, 2016); Willis et al., 3d print adhesion reduction during cure process, US Patent Application Pub. No. US 2015/0360419 (Dec. 17, 2015); Lin et al., Intelligent 3d printing through optimization of 3d print parameters, US Patent Application Pub. No. US 2015/0331402 (Nov. 19, 2015); and D. Castanon, Stereolithography System, US Patent Application Pub. No. US 2017/0129167 (May 11, 2017).

Numerous photopolymerizable resins for additive manufacturing of polymer articles are known. Examples include, but are not limited to, those set forth in DeSimone et al., U.S. Pat. Nos. 9,211,678; 9,205,601; and 9,216,546; and in Rolland et al., U.S. Pat. Nos. 9,676,963; 9,598,606; and 9,453,142.

2. Light-Based Additive Manufacturing with Light Source Variability Correction.

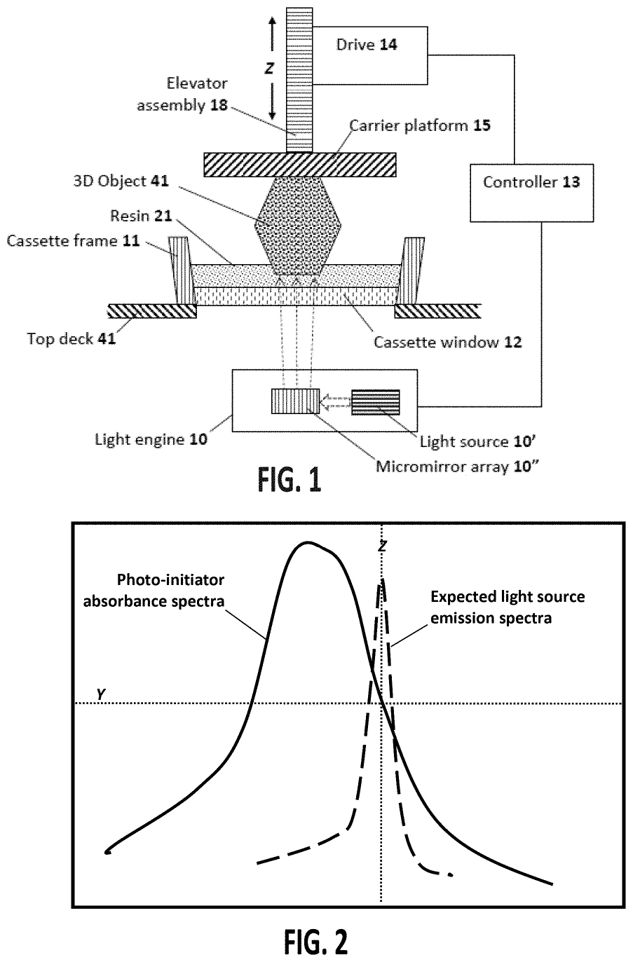

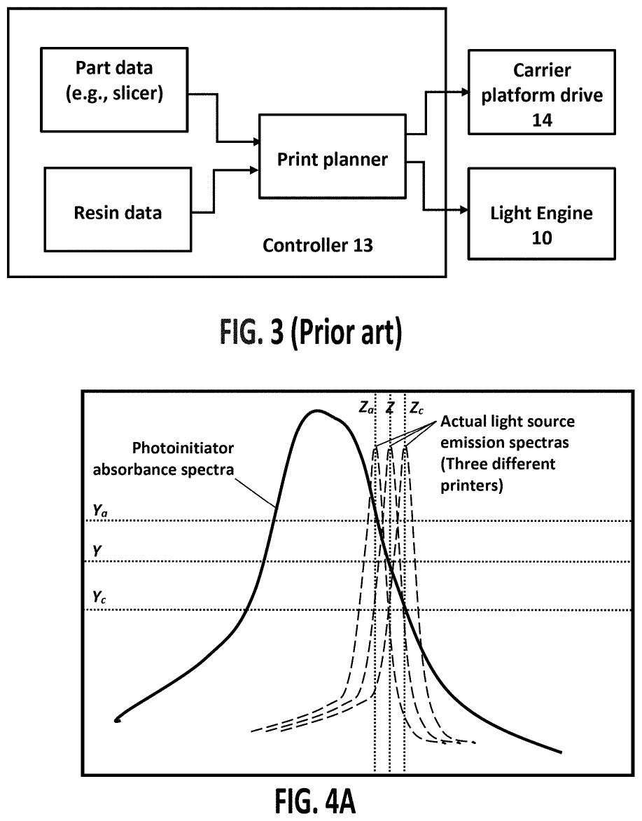

An example additive manufacturing apparatus is schematically illustrated in FIG. 1. Such an apparatus generally includes:
(a) A light transmissive window (12) on which a light-polymerizable resin (21) can be supported. The window can be provided in a removable cassette within a frame (11) that can be mounted on the top deck (41) of the apparatus.
(b) An elevator assembly (18) including a drive (14) operatively associated therewith, assembly a part may be produced from the light polymerizable resin by additive manufacturing. Typically the part is produced on a removable carrier platform connected to the elevator assembly (15).
(c) A light source (10′) positioned below said window and configured (often with a micromirror array 10″ and associated optical components, not shown, within a light engine 10); to project light that is patterned over space and time through the window to produce at least one part on the elevator assembly (and preferably on the carrier platform). Examples of suitable light sources include, but are not limited to, a light emitting diode (LED) light source (including multi-LED arrays); a laser light, a halogen lamp, etc., all of which may be emitting at a peak wavelength in the UV or visible light range.
(d) A controller (13) is operatively associated with the elevator assembly (via the drive) and the light source (and associated components of the light engine such as the micromirror array), the controller configured for operating the apparatus to carry out the additive manufacturing process.

The controller operation is typically configured to carry out the process based, in part, on resin photosensitivity (discussed further below), a component of which is the resin's photointiator absorbance spectra. The absorbance spectra (and resin photosensitivity) do not typically overlap perfectly with the expected light source emission spectra, as schematically illustrated in FIG. 2, and overall resin characteristics can vary from resin batch-to-batch (resulting in print variability and accuracy problems in the additively manufactured parts). Hence, more advanced controllers/print planners will take into consideration, and adjust for, variations in resin photosensity, as described on Tumbleston et al., Performance optimization in additive manufacturing, US Patent Application Pub. App. No. US 2020/0276765 (Sep. 3, 2020), the disclosure of which is incorporated by reference herein in its entirety.

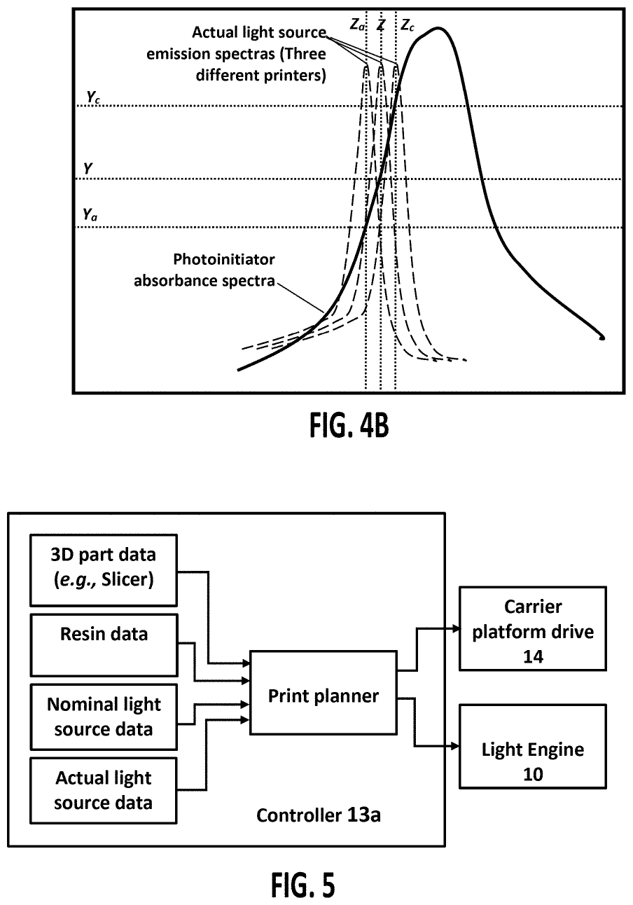

However, actual light source emission data can also contribute to part production variability. For example, any lot of light sources can have a range of actual emission spectra that deviate significantly from their expected (or “bin value”) emission spectra. Examples of how these may deviate, in comparison to various photoinitiator absorbance spectra, are given in FIGS. 4A-4B, where Zₐ, Z_{b}, and Z_{c} represent emission spectra peak (just one aspect of an overall emission spectra), and Yₐ, Y_{b}, and Y_{c} indicate where those peaks align with the photoinitiator absorbance spectra (note the potential for significant differences in alignment, which cause significant differences in photoinitiation efficacy, resulting in accuracy error when the actual light source emission spectra differs from the nominal, or expected, emission spectras.

Accordingly, the present invention provides a method of reducing performance deviation in at least one additive manufacturing apparatus during production of parts therein. Each apparatus has a light source configured for polymerizing a light polymerizable resin with sequential doses of patterned light to produce a three-dimensional (3D) object, the light source having assigned nominal (i.e., expected or preset standard) emission data and actual emission data. The method includes: modifying at least some of the light doses in each at least one apparatus during production of the parts to compensate for a deviation of the actual light source emission data from the assigned nominal emission data.

In some embodiments, the at least one additive manufacturing apparatus comprises a group of (e.g., a plurality or fleet of at least 2, 3, or 4) individual additive manufacturing apparatus, all assigned the same nominal emission data. In such embodiments the modifying step is carried out by modifying the light doses in each individual apparatus to compensate for a deviation of said actual light source emission data of each individual apparatus from the nominal light source emission data assigned all to all of the apparatus. In some cases, such a method is carried out with all of the apparatus loaded with the same polymerizable resin for the modifying step (i.e., same catalog number or supplier number) and in some cases the method is carried out with all of the apparatus loaded with an identical polymerizable resin for the modifying step (i.e., resin coming from the same container or production batch).

In some embodiments, the actual emission data is predetermined (e.g., measured for each light source when said light source is installed in the additive manufacturing apparatus, or during a service check of an in-use apparatus).

In some embodiments, the actual emission data is periodically determined (e.g. determined contemporaneously for manufacturing objects with a specific resin batch from which objects are to be made with said at least one additive manufacturing apparatus). In some embodiments, this can be done by including in the apparatus at least one light sensor (such as a spectrophotometer) operatively associated the light source, and the actual emission data periodically determined with the at least one light sensor. However, in other embodiments where the actual emission data is periodically determined, this can be done with an empirical model (e.g. a linear regression model), a first principles model, or a combination thereof from: (i) previously measured light source emission data (e.g., data collected from the light source when first installed in the apparatus, data collected from the light source during a servicing or updating of a previously installed light source, etc.) and (ii) actual light source use data (e.g., temperature at the light source at the present time, electrical current to the light source at the present time, circuit resistance and/or voltage, lifetime use (total on time up to the present time) of the light source), ambient pressure of the manufacturing apparatus, ambient temperature of the additive manufacturing apparatus, and combinations of the foregoing. Thus, the actual emission data may be directly or indirectly measured and/or estimated based on various parameters, including measured data from sensors mounted on the apparatus or data collected periodically using one or more mobile sensors or measurement device.

In some embodiments, the actual emission data and the nominal emission data consists of a single parameter (e.g., an emission spectra peak value). In other embodiments, however, the actual emission data and the nominal emission data comprise multi-parameter data. Examples of multi-parameter data include, but are not limited to, an emission spectra peak value in combination with a full width at half maximum value; a set of intensity values measured at a plurality (e.g., from 2 or 3 to 20 or 30 or more) of pre-determined wavelength values; an integrated spectral power, a spectral density distribution, etc. For example, any of the preceding emission data types measured at a plurality of spatial coordinates (e.g. rectilinear locations on a plane, angular locations on the surface of a sphere, or the like) to capture spatial variations in the data; a spectral distribution measured as a function of angle of observation; etc.

In some embodiments, the actual emission data is periodically determined by fitting a distribution (e.g., a Normal or Cauchy distribution) to a measured spectrum.

In some embodiments, the modifying of doses is carried out by: (i) when the resin photosensitivity is greater at the actual light source emission data than at the nominal data, then the exposure dose is decreased and/or overcure and cure-through compensations are increased; or (ii) when the resin photosensitivity is less at the actual light source emission data than at the nominal data, then the exposure dose is increased and/or overcure and cure-through compensations are reduced. In some embodiments, resin photosensitivity comprises resin total absorption (e.g., alpha), resin onset of cure (F_{C} or D_{C}), or a combination thereof. In some embodiments, the exposure dose, overcure compensations, and/or cure-through compensations are increased or decreased based on a first principles model, an empirical model, or a combination thereof, as noted above and discussed further below.

Returning to the apparatus discussed above, the controller that is operatively associated with the elevator assembly and light source is preferably a controller (13a) as shown in FIG. 5, and is configured to include nominal light source data and actual light source data as described above in operating the apparatus to carrying out methods as described above.

Parts for production. In some embodiments, the apparatus is producing multiple copies of the same part, or the fleet of apparatus are producing multiple copies of the same part. Note, however, that “same part” are not necessarily identical parts. For example, in some cases, such as the production of an electrical connector, a mechanical connector, a fluid connector, a microelectronic device, a mechanical or micromechanical device, a fluidic or microfluidic device, or the like, all of the parts produced on the apparatus or fleet of apparatus may be identical (and typically with multiple copies produced simultaneously on the same build platform). In other cases, however, such as for the production of a dental model, a dental model die, a dental appliance (e.g. a dental crown, a dental implant, a denture, a dental crown, a dental bridge, a night guard)), a dental appliance thermoforming mold, or a surgical guide, the parts are similar or analogous (and often multiple copies produced simultaneously on the same build platform) but may vary depending on patient-to-patient differences, and/or treatment stage for the patient (for example, for thermoforming molds for progressive dental aligners). In general, the processes described herein are particularly useful for the production of parts that require a high level of accuracy: for example, where the parts are produced to tolerance of plus or minus (+/−) 100, 50, 30, or 20 micrometers, or less.

### 3. Example Correction Models.

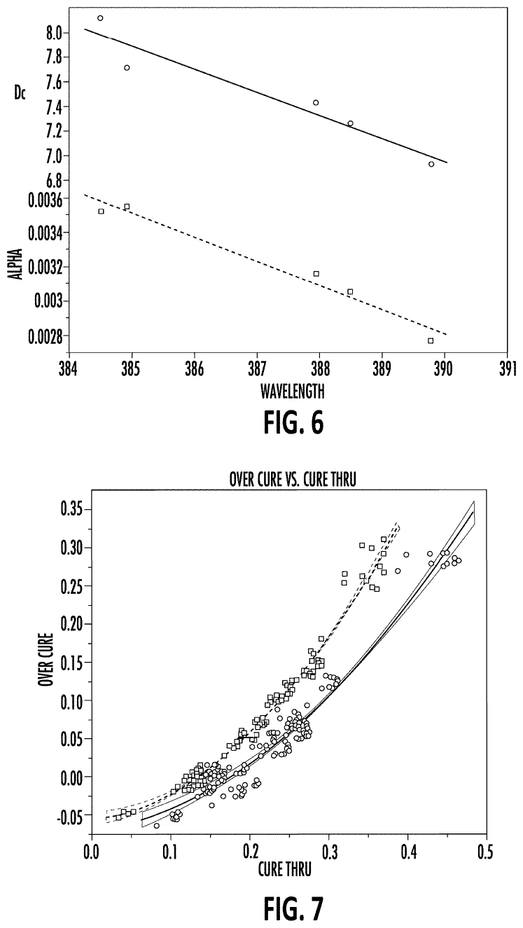

Wavelength printing adjustment may be carried out by first determining the change in cure characteristics of a particular resin (specifically, resin total absorption (alpha) and resin onset of cure (F_{C} or D_{C})), across wavelengths, as illustrated in FIG. 6.

These data are then used to determine the expected cure-through and overcure for the resin at a printer's actual wavelength using a first principles (CCT) model and an empirical (OCC) model, in combination.

Data such as given in FIG. 6 above is used in a first principles model to give expected cure-through. A first principles model can be based on the process described in connection with Equation 2 of Tumbleston et al., Continuous liquid interface production of 3D objects, Science 347, 1349-1352 (20 Mar. 2015) (inserted below for convenient reference):

$$Cured thickness = \frac{1}{α} ln ( \frac{{Φ}_{0} {α}_{P 1} t}{{D}_{c 0}} ) \qquad ( 2 )$$

adapted to take into consideration additional, subsequent, exposure slices that contribute to cure-through during production of a three-dimensional object.

The empirical model illustrated in FIG. 7 and the equations below:

100 um OCC=−0.05622+0.104*Z_{ct}+2.297*Z_{ct}²

50 um OCC=−0.0846+0.132*Z_{ct}+1.366*Z_{ct}²

Are then used to give expected overcure. Since the empirical model is slice thickness dependent, two different examples at different slice thicknesses are given.

These procedures allow one to calculate the expected curethrough and overcure at a nominal wavelength and then at a printers' actual wavelength, thereby allowing exposure adjustments to make parts print as though they were printed at the nominal wavelength. And enhancing overall accuracy of the process, both for individual additive manufacturing apparatus, and fleets of apparatus. Such accuracy enhancement is important for the production of a variety of additively manufactured parts, including but not limited to:
Dental model dies, where 10's of micron differences in dimensions can have noticeable effects on the quality of fit.
Dental model analogs, where a metal analog is press fit into a model, and again 10's of micron differences in dimensions can have a noticeable effect on the fit.
Crowns and other dental restorations, where the fit thereof on a dental model will better mimic how a crown will fit in a patient, since models will be more accurate and consistent. Crown fit against neighboring teeth is often checked with shims only 7 microns thick, so again having accuracy improvements on the order of 10's of microns provides a significant improvement.
Surgical guides, for example, where the fit of metal sleeves that are press fitted into surgical guides can be more consistent if there is less variability in parts.
Final dental appliances (such as dentures, crowns, bridges, and night guards), where their fit in the patient can be more accurate and consistent. For example, printed permanent crown and bridge restorations in particular will require great accuracy, as deviations on the order of 10's of microns will affect how tightly a crown fits against neighboring teeth.
Models that are molds for thermoforming dental aligners. For such additively manufactured molds, many manufactures print fixtures on their molds that ultimately mate with downstream equipment such as thermoforming machines or aligner trimming machines. The processes described herein can help achieve more accurate and consistent fixture dimensions.

Although embodiments of the present invention are described with respect to a controller, it should be understood that operations performed by the controller may be performed by a single device or by multiple devices or processors, including devices in a computer network that may be physically separated from the three dimensional additive manufacturing device(s).

Example embodiments of the present invention may be embodied in various devices, apparatuses, and/or methods. For example, example embodiments of the present invention may be embodied, in whole or in part, in hardware and/or in software (including firmware, resident software, micro-code, etc.). Furthermore, example embodiments of the present invention may take the form of a computer program product comprising a non-transitory computer-usable or computer-readable storage medium having computer-usable or computer-readable program code embodied in the medium for use by or in connection with an instruction execution system. In the context of this document, a computer-usable or computer-readable medium may be any medium that can contain, store, communicate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, or device. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Example embodiments of the present invention are described herein with reference to flowchart and/or block diagram illustrations. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the functions specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

The foregoing is illustrative of the present invention, and is not to be construed as limiting thereof. The invention is defined by the following claims, with equivalents of the claims to be included therein.

1. A method of reducing performance deviation in at least one additive manufacturing apparatus during production of parts, each apparatus having a light source configured for polymerizing a light polymerizable resin with sequential doses of patterned light to produce a three-dimensional (3D) part, the light source having assigned nominal emission data and actual emission data, the method comprising:
modifying at least some of said light doses in said at least one apparatus during production of said parts to compensate for a deviation of said actual light source emission data from said assigned nominal emission data.

2. The method of claim 1, wherein said at least one additive manufacturing apparatus comprises a group of individual additive manufacturing apparatus, all assigned the same nominal emission data, and said modifying step comprises:
modifying said light doses in each individual apparatus to compensate for a deviation of said actual light source emission data of each individual apparatus from the nominal light source emission data assigned all of said apparatus.

3. The method of claim 2, wherein all of said apparatus are loaded with a same polymerizable resin for said modifying step.

4. The method of claim 1, wherein said actual emission data is predetermined.

5. The method of claim 1, wherein said actual emission data is periodically determined contemporaneously for manufacturing objects with a specific resin batch with said at least one additive manufacturing apparatus.

6. The method of claim 5, wherein said apparatus includes at least one light sensor operatively associated with said light source, and said actual emission data is periodically determined with said at least one light sensor.

7. The method of claim 5, wherein said actual emission data is periodically determined with an empirical model, a first principles model, or a combination thereof from:
(i) previously measured light source emission data; and
(ii) actual light source use data, and optionally at least one other apparatus use data.

8. The method of claim 1, wherein said actual emission data and said nominal emission data consists of a single parameter comprising an emission spectra peak value.

9. The method of claim 1, wherein said actual emission data and said nominal emission data comprise multi-parameter data.

10. (canceled)

11. The method of claim 1, wherein said modifying comprises:
when the resin photosensitivity is greater at the actual light source emission data than at the nominal data, then the exposure dose is decreased and/or overcure and cure-through compensations are increased; and
when the resin photosensitivity is less at the actual light source emission data than at the nominal data, then the exposure dose is increased and/or overcure and cure-through compensations are reduced.

12. The method of claim 11, wherein said resin photosensitivity comprises resin total absorption, resin onset of cure (F_{C} or D_{C}), or a combination thereof.

13. The method of claim 11, wherein exposure dose, overcure compensations, and/or cure-through compensations are increased or decreased based on a first principles model, an empirical model, or a combination thereof.

14. (canceled)

15. The method of claim 1, wherein: all of said at least one additive manufacturing apparatus are producing a same part.

16. The method of claim 15, wherein said parts are produced to tolerance of plus or minus (+/−) 100 micrometers or less.

17. The method of claim 1, wherein said parts comprise an electrical connector, a mechanical connector, a fluid connector, a microelectronic device, a mechanical or micromechanical device, a fluidic or microfluidic device, a dental model, a dental model die, a dental appliance, a dental appliance thermoforming mold, or a surgical guide.

18. At least one additive manufacturing apparatus, each of said at least one apparatus comprising:
(a) a light transmissive window on which a light-polymerizable resin may be supported;
(b) an elevator assembly and drive positioned above said window, on which elevator assembly a part may be produced from the light polymerizable resin on a carrier platform mounted to the elevator assembly;
(c) a light source positioned below said window and configured to project light that is patterned over space and time through the window to produce at least one part on the elevator assembly (and preferably on the carrier) platform; and
(d) a controller operatively associated with said elevator assembly and light source, said controller configured for carrying out a method of any preceding claim during additive manufacturing of a part with said apparatus.

19. The at least one apparatus of claim 20, wherein the at least once apparatus comprises a group of said additive manufacturing apparatus all assigned a same nominal emission data.

20. An additive manufacturing apparatus comprising:
(a) a light transmissive window on which a light-polymerizable resin may be supported;
(b) an elevator assembly and drive positioned above said window, on which elevator assembly a part may be produced from the light polymerizable resin on a carrier platform mounted to the elevator assembly;
(c) a light source positioned below said window and configured to project light that is patterned over space and time through the window to produce at least one part on the elevator assembly and on the carrier platform, the light source having an assigned nominal emission data and actual emission data; and
(d) a controller operatively associated with said elevator assembly and light source, said controller configured to modify at least some of said light doses of said light source during production of said parts to compensate for a deviation of said actual light source emission data from said assigned nominal emission data.

21. The apparatus of claim 20, wherein said actual emission data is predetermined.

22. The apparatus of claim 20, wherein said actual emission data is periodically determined.

23.-50. (canceled)
